(19) United States
(12) Patent Application Publication
(10) Pub. No.: US 2026/0025881 A1
(43) Pub. Date: Jan. 22, 2026

(54) ELECTRONIC DEVICE, COMMUNICATION CONTROL METHOD AND STORAGE MEDIUM

(71) Applicant: CASIO COMPUTER CO., LTD., Tokyo (JP)

(72) Inventor: Yuuki OSHITA, Tokyo (JP)

(21) Appl. No.: 19/270,927

(22) Filed: Jul. 16, 2025

(30) Foreign Application Priority Data
Jul. 17, 2024 (JP) 2024-113926

(51) Int. Cl. H04W 76/28; H04W 52/02

(52) U.S. Cl. CPC H04W 76/28; H04W 52/0251

(57) ABSTRACT

An electronic device includes a processor and a communicator that communicates with an external communication device via a server. The communicator discontinuously awaits data reception from the server with a predetermined waiting interval. The processor performs a shortening process to shorten the waiting interval in response to the communicator receiving a certain notification via the server, and after performing the shortening process, performs an extension process to extend the waiting interval in response to a certain condition being satisfied.

### REFERENCE TO RELATED APPLICATIONS

This application is based upon and claims the benefit of priority from the prior Japanese Patent Application No. 2024-113926, filed on Jul. 17, 2024, the entire contents, including the description, claims, abstract and drawings, of which are incorporated herein by reference.

### TECHNICAL FIELD

The present disclosure relates to an electronic device, a communication control method and a storage medium.

### DESCRIPTION OF RELATED ART

As disclosed in WO 2020/170396 A1, there has been known a technology for an electronic device provided with a wireless communication function to reduce power consumption by discontinuously waiting for the start of communication with an external communication device at predetermined waiting intervals.

### SUMMARY OF THE INVENTION

According to an aspect of the present disclosure, there is provided an electronic device including:
a processor; and
a communicator that communicates with an external communication device via a server,
wherein the communicator discontinuously awaits data reception from the server with a predetermined waiting interval, and
wherein the processor
   performs a shortening process to shorten the waiting interval in response to the communicator receiving a certain notification via the server, and
   after performing the shortening process, performs an extension process to extend the waiting interval in response to a certain condition being satisfied.

### BRIEF DESCRIPTION OF DRAWINGS

FIG. 1 illustrates the configuration of a communication system.

FIG. 2 is a block diagram illustrating a functional configuration of an electronic timepiece.

FIG. 3 is a block diagram illustrating a functional configuration of an administrator terminal.

FIG. 4 illustrates eDRX.

FIG. 5 illustrates eDRX cycles in LTE-M and NB-IoT.

FIG. 6 illustrates MQTT protocol.

FIG. 7 illustrates a switching operation between eDRX and DRX.

FIG. 8 illustrates a flow of data transmission/reception between the electronic timepiece and the administrator terminal.

FIG. 9 illustrates another flow of data transmission/reception between the electronic timepiece and the administrator terminal.

FIG. 10 illustrates a flow of data transmission/reception in a modification.

FIG. 11 is a flowchart illustrating a control procedure for a shortening control process in the modification.

FIG. 12 is a flowchart illustrating another control procedure for the shortening control process in the modification.

### DETAILED DESCRIPTION

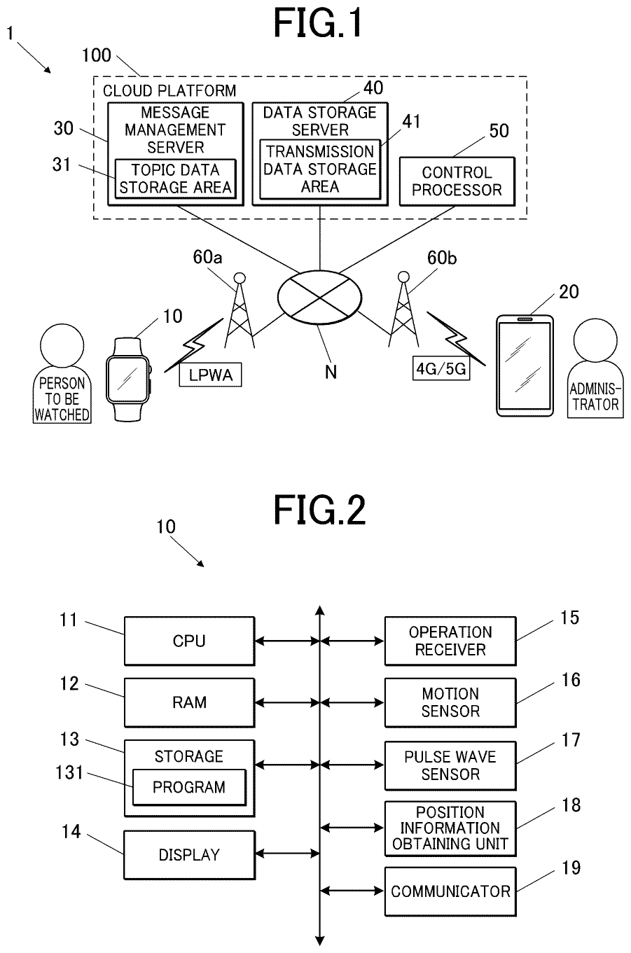

Hereinafter, one or more embodiments of the present disclosure will be described with reference to the drawings. As illustrated in FIG. 1, a communication system 1 includes an electronic timepiece 10 (electronic device), an administrator terminal 20 (communication device) and a cloud platform 100. The cloud platform 100 is composed of various types of hardware and software and/or the like to realize cloud computing, and includes, for example, physical servers provided at one or more data centers. The cloud platform 100 includes a message management server 30 (server or first server), a data storage server 40 (server or second server) and a control processor 50. The message management server 30 and the data storage server 40 may be physical servers each including a central processing unit (CPU), a random access memory (RAM) and a storage, or may be virtual servers virtually constructed by using part of hardware of one or more physical servers. The electronic timepiece 10 and the administrator terminal 20 are both capable of data communication with the message management server 30 and the data storage server 40 via a network N. The electronic timepiece 10 is capable of data communication (communication) with the administrator terminal 20 via the message management server 30 or the data storage server 40. The network N is not limited to but may include networks for a mobile communication(s) provided by a mobile network operator(s) and the Internet.

The electronic timepiece 10 is, for example, a smartwatch, and is worn or carried by a person to be watched. The person to be watched is a person to be watched by an administrator, and is, for example, a child, an elderly person or a patient. The electronic timepiece 10 is capable of wireless communication by low-power, wide-area (LPWA) communication, which hereinafter may be simply referred to as “LPWA”, with a base station 60 (base station 60a in FIG. 1) connected to the network N. Thus, the electronic timepiece 10 can perform data communication with the message management server 30 and the data storage server 40 via the base station 60 and the network N.

As illustrated in FIG. 2, the electronic timepiece 10 includes a CPU 11, a RAM 12, a storage 13, a display 14, an operation receiver 15, a motion sensor 16, a pulse wave sensor 17, a position information obtaining unit 18 and a communicator 19. These components of the electronic timepiece 10 are connected with one another via a data transmission path, such as a bus. The electronic timepiece 10 also includes a not-shown battery, and the components of the electronic timepiece 10 operate by electric power supplied from the battery.

The CPU 11 is a processor that reads and executes programs 131 stored in the storage 13 and performs various types of arithmetic processing, thereby controlling the operation of each component of the electronic timepiece 10. The electronic timepiece 10 may have two or more processors (e.g., two or more CPUs), and multiple processes that are performed by the CPU 11 in this embodiment may be performed by the two or more processors. The RAM 12 provides a working memory space for the CPU 11 and stores temporary data.

The storage 13 is a non-transitory storage medium readable by the CPU 11 as a computer and stores the programs 131 and various data. The storage 13 includes, for example, a nonvolatile memory, such as a flash memory. The programs 131 are stored in the storage 13 in the form of computer-readable program code. Examples of the various data stored in the storage 13 include setting data pertaining to operation settings of the electronic timepiece 10, and text data and voice data received from the administrator terminal 20.

The display 14 displays, for example, various operation screens and information display screens under the control of the CPU 11. The display 14 to be used is not limited to but may be a liquid crystal display device that performs display with a dot matrix method. The operation receiver 15 receives input operations made by the user (person to be watched) and outputs, to the CPU 11, input signals corresponding to the input operations. The operation receiver 15 includes a touchscreen superimposed on the display screen of the display 14, and detects contacts of the user's finger or the like on and with the touchscreen as input operations. The operation receiver 15 may include hardware buttons in addition to or instead of the touchscreen.

The motion sensor 16 includes a three-axis acceleration sensor and a three-axis angular velocity sensor. The motion sensor 16 detects the acceleration and the angular velocity that are generated in the electronic timepiece 10 in response to a movement of a wrist of the person to be watched, and outputs the detected data to the CPU 11. On the basis of the detected data by the motion sensor 16, the CPU 11 estimates a movement (e.g., walking and the number of steps, eating, sleeping, etc.) being performed by the person to be watched.

The pulse wave sensor 17 includes a light emitting element that emits green light, which is easily absorbed by hemoglobin in blood, and a light receiving element that detects, of this light, light reflected by skin. The pulse wave sensor 17 detects a pulse wave of the wrist of the person to be watched on the basis of a change in intensity of the light detected by the light receiving element, and outputs the detected data to the CPU 11. The CPU 11 calculates a heart rate on the basis of the waveform of the detected pulse wave.

The position information obtaining unit 18 calculates the current position by receiving and decoding radio waves transmitted from positioning satellites of the global navigation satellite system (GNSS), such as the Global Positioning System (GPS). The position information obtaining unit 18 calculates the current position under the control of the CPU 11 and outputs the result to the CPU 11.

The communicator 19 includes an LPWA module for wireless communication conforming to the LPWA communication standard. The LPWA module includes an antenna, a modulation-and-demodulation circuit and a signal processing circuit conforming to the LPWA communication standard. The communicator 19 performs LPWA wireless communication with the base station 60 using the LPWA module, thereby performing data communication with the message management server 30 and the data storage server 40.

The administrator terminal 20 illustrated in FIG. 1, which is a smartphone in this embodiment, is a device that is operated by the administrator who watches the person to be watched. However, the administrator terminal 20 is not limited to this example but may be a tablet terminal, a smartwatch, a laptop personal computer (PC) or the like. The administrator terminal 20 is capable of 4G/5G wireless communication with a base station 60 (base station 60b in FIG. 1) connected to the network N. Thus, the administrator terminal 20 can perform data communication with the message management server 30 and the data storage server 40 via the base station 60 and the network N. In this specification, the “4G/5G” refers to one of wireless standards that use public lines (licensed bands) having a communication speed higher than Cat. 1 described later. Therefore, the “4G/5G” includes 4G (fourth generation mobile communication system) and 5G (fifth generation mobile communication system) having a communication speed (e.g., theoretical maximum speed) higher than 4G. The “4G/5G” further includes Beyond 5G (6G) having a communication speed higher than 5G. In this specification, the “LPWA” is defined as and used for wireless standards that use public lines having a communication speed equal to or lower than Cat. 1 and communication standards for IoT that use nonpublic lines (unlicensed bands), such as LoRaWAN and Sigfox. The administrator terminal 20 may be capable of data communication with the message management server 30 and the data storage server 40 via a communication path that does not involve the base station 60, such as a wireless LAN or wired communication.

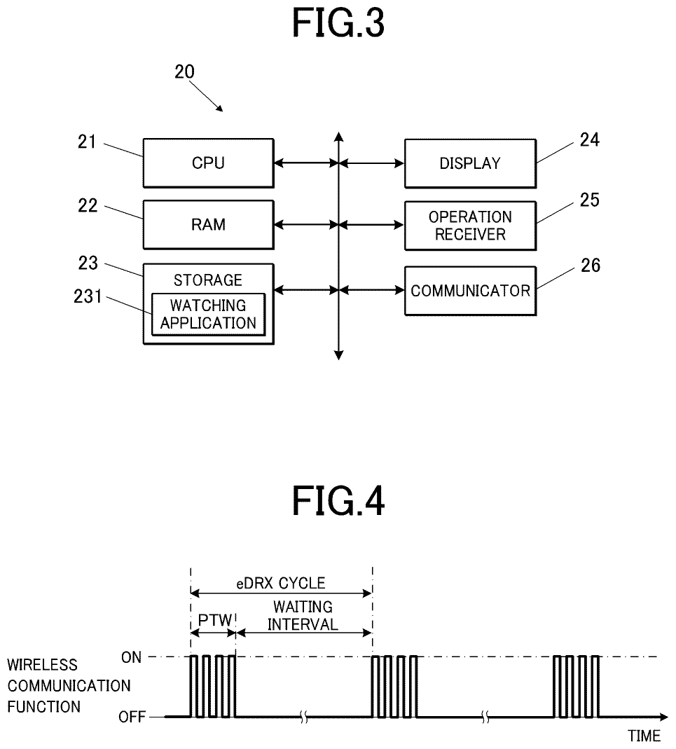

As illustrated in FIG. 3, the administrator terminal 20 includes a CPU 21, a RAM 22, a storage 23, a display 24, an operation receiver 25 and a communication 26. These components of the administrator terminal 20 are connected with one another via a data transmission path, such as a bus. The administrator terminal 20 includes a not-shown battery, and the components of the administrator terminal 20 operate by electric power supplied from the battery.

The CPU 21 is a processor that reads and executes programs including a watching application 231 stored in the storage 23 and performs various types of arithmetic processing, thereby controlling the operation of each component of the administrator terminal 20. The RAM 22 provides a working memory space for the CPU 21 and stores temporary data. The storage 23 stores the programs including the watching application 231 and various data. The storage 23 includes, for example, a nonvolatile memory, such as a flash memory. The watching application 231 is an application program for a watching service to watch the person to be watched using the communication system 1. Examples of the various data stored in the storage 23 include setting data pertaining to operation settings of the administrator terminal 20, and state data, text data and voice data received from the electronic timepiece 10.

The display 24 displays various types of information, such as an information screen(s) of the watching application 231, on the basis of control signals transmitted from the CPU 21. The display 24 to be used is not limited to but may be a liquid crystal display device. The operation receiver 25 receives input operations made by the user (administrator) and outputs, to the CPU 21, input signals corresponding to the input operations. The operation receiver 25 includes a touchscreen superimposed on the display screen of the display 24, and detects contacts of the user's finger or the like on and with the touchscreen as input operations. The operation receiver 25 may include hardware buttons in addition to or instead of the touchscreen.

The communicator 26 includes a 4G/5G module for wireless communication conforming to the 4G/5G communication standard. The 4G/5G module includes an antenna, a modulation-and-demodulation circuit and a signal processing circuit conforming to the 4G/5G communication standard. The communicator 26 performs 4G/5G wireless communication with the base station 60 using the 4G/5G module, thereby performing data communication with the message management server 30 and the data storage server 40.

The message management server 30 illustrated in FIG. 1 functions as a broker in a case where the electronic timepiece 10 and the administrator terminal 20 perform communication in accordance with the message queuing telemetry transport (MQTT) protocol. The message management server 30 includes a topic data storage area 31 where data of topics in the MQTT protocol described later are temporarily stored. The message management server 30 performs data communication with the electronic timepiece 10 and the administrator terminal 20 via the network N by its not-shown communicator performing a communication operation.

The data storage server 40 functions as a server in the hyper text transfer protocol (HTTP), which is a server-client communication protocol, and stores various data transmitted from the electronic timepiece 10 and the administrator terminal 20. The data storage server 40 includes a transmission data storage area 41 where data transmitted/received in HTTP are temporarily stored. The data storage server 40 performs data communication with the electronic timepiece 10 and the administrator terminal 20 via the network N by its not-shown communicator performing a communication operation.

The control processor 50 performs various control processes in response to occurrence of events (data registration, data deletion, etc.) in the data storage server 40. The control processor 50 may be provided at a physical server or virtual server different from either of the message management server 30 and the data storage server 40, or may be included in the data storage server 40.

Next, the operation of the communication system 1 will be described. In the communication system 1 of this embodiment, state data including information on the state of the person to be watched, text data including a text message, voice data including a voice message, and so forth can be transmitted/received between the electronic timepiece 10 worn by the person to be watched and the administrator terminal 20 used by the administrator. The state data includes, for example, information on the movement of the person to be watched derived on the basis of the data of the acceleration and the angular velocity detected by the motion sensor 16 of the electronic timepiece 10, information on the heart rate of the person to be watched calculated on the basis of the data detected by the pulse wave sensor 17, and information on the current position of the person to be watched (or the electronic timepiece 10) calculated by the position information obtaining unit 18. The state data, text data and voice data are transmitted from one of the electronic timepiece 10 and the administrator terminal 20 to the message management server 30 or the data storage server 40 via the network N and once stored therein, and the other of the electronic timepiece 10 and the administrator terminal 20 receives (obtains) these data from the message management server 30 or the data storage server 40. These data are transmitted/received by the communicator 19 of the electronic timepiece 10, the communicator 26 of the administrator terminal 20, the not-shown communicator of the message management server 30 and the not-shown communicator of the data storage server 40. However, for convenience, it may be rephrased hereinafter as follows: data are transmitted/received by the electronic timepiece 10, the administrator terminal 20, the message management server 30 and the data storage server 40.

As described above, the electronic timepiece 10 performs LPWA wireless communication with the base station 60, and performs data communication with the message management server 30 and the data storage server 40 via a communication path that includes the path for the LPWA wireless communication. The “LPWA” is a generic name of communication standards in which wide area communication with low power consumption can be performed. LPWA is a communication standard(s) that enables long-distance communication with lower power consumption with the communication speed (bit rate) reduced and the noise immunity improved as compared to the mobile communication standards for cellular phones, such as 4G and 5G. While 4G/5G can realize a communication speed of 100 Mbps or higher, LPWA offers a communication speed of, for example, 1 Mbps or lower (in the case of LTE-M described later). Further, LTE Cat. 1 offers an uplink communication speed of 5 Mbps or lower and a downlink communication speed of 10 Mbps or lower. The communicable distance of LPWA is longer than that of 4G/5G. The communication distance of LPWA is, for example, about 10 km, but can be 50 km or longer depending on the environment. Using LPWA, which enables long-distance wireless communication with low power consumption, can reduce electric power used for wireless communication and ensure a sufficient continuous operation time in the electronic timepiece 10 having a small case and a limited battery capacity.

There are two types of LPWA. One is the licensed-band LPWA, which uses frequency bands allocated to mobile network operators, and the other is the unlicensed-band LPWA, which uses frequency bands other than those mentioned above. Of these, the licensed-band LPWA includes LTE Cat. 1, LTE-M (LTE Cat. M1) and NB-IoT (LTE Cat. NB1), which are standardized as part of long-term evolution (LTE). The electronic timepiece 10 of this embodiment uses LTE-M.

Conventionally, in mobile data communications that are performed by mobile devices, such as cellular phones, a function called discontinuous reception (DRX) of discontinuously waiting for a paging message as a call from the base station 60 at predetermined waiting intervals (on a predetermined discontinuous waiting cycle) is used to reduce power consumption. The standard value for the discontinuous waiting cycle in DRX, which is hereinafter referred to as “DRX cycle” (second cycle), is 1.28 seconds. In contrast, in LPWA, such as LTE Cat. 1, LTE-M and NB-IoT, a function called extended discontinuous reception (eDRX), in which the discontinuous waiting cycle is significantly longer than that in DRX, is used to further reduce power consumption.

With reference to FIG. 4, eDRX will be described. In FIG. 4, the horizontal axis represents time, and the vertical axis represents ON/OFF of the LPWA wireless communication function of the electronic timepiece 10 at each point in time (time point). If the electronic timepiece 10 receives a paging message in a period during which the wireless communication function is ON, the electronic timepiece 10 starts LPWA communication. On the other hand, in a period during which the wireless communication function is OFF, the electronic timepiece 10 does not receive a paging message and accordingly does not start LPWA communication. A paging time window (PTW) illustrated in FIG. 4 represents a waiting period during which the wireless communication function is repeatedly turned on and the electronic timepiece 10 tries to receive a paging message. On the other hand, in the period other than the PTW, the wireless communication function remains off and the electronic timepiece 10 does not try to receive a paging message. The period from the start timing of one PTW to the start timing of the next PTW is the discontinuous waiting cycle in eDRX. It is a cycle of discontinuously waiting for the start of communication. It may be rephrased as a discontinuous reception cycle. Hereinafter, it is referred to as “eDRX cycle” (first cycle). The period obtained by subtracting a PTW from an eDRX cycle corresponds to a waiting interval. In the period corresponding to the waiting interval, the CPU 11 temporarily stops power supply to the modulation-and-demodulation circuit, the signal processing circuit and so forth of the LPWA module of the communicator 19, thereby reducing power consumption of the electronic timepiece 10.

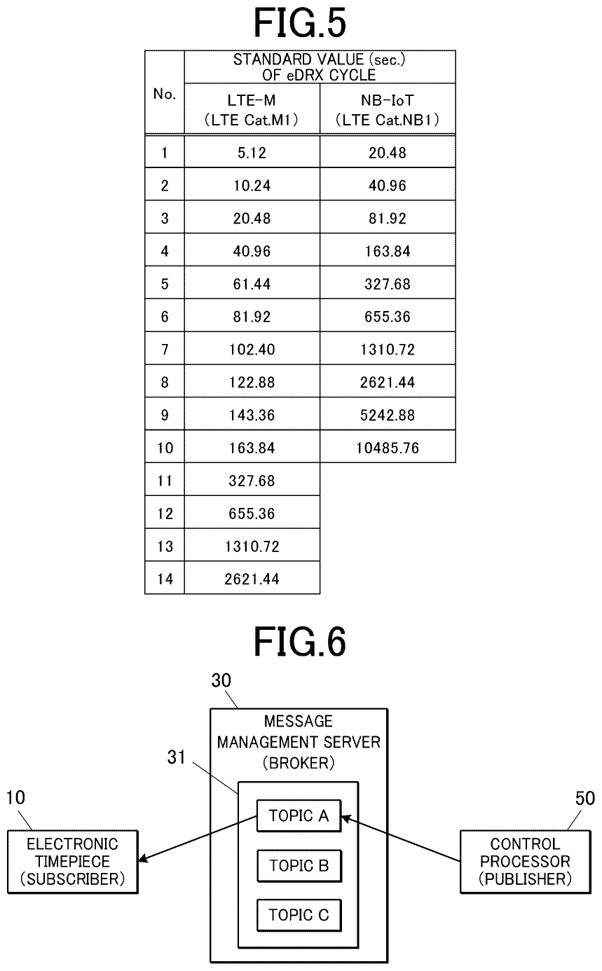

As illustrated in FIG. 5, in LTE-M, the eDRX cycle can be set at one of 14 standard values ranging from 5.12 seconds to 2621.44 seconds (approximately 44 minutes), whereas in NB-IoT, the eDRX cycle can be set at one of 10 standard values ranging from 20.48 seconds to 10485.76 seconds (approximately 175 minutes). Thus, the eDRX cycle in LTE-M and the eDRX cycle in NB-IoT are both longer than the DRX cycle (1.28 seconds). If the PTW is fixed, the longer the eDRX cycle, the longer the waiting interval. This can reduce power consumption more effectively.

Although not illustrated, the PTW is also selectable from two or more standard values. For example, in LTE-M, the PTW can be set at one of 15 standard values ranging from 1.28 seconds to 20.48 seconds. If the eDRX cycle is fixed, the shorter the PTW, the longer the waiting interval. This can reduce power consumption more effectively.

The electronic timepiece 10 of this embodiment can switch the waiting cycle of awaiting data reception from the outside between the DRX cycle and the eDRX cycle. The DRX cycle or the eDRX cycle and the PTW set in the electronic timepiece 10 are shared by the electronic timepiece 10, the base station 60 and a not-shown mobility management entity (MME) as a network facility. The MME manages positions of communication terminals such as the electronic timepiece 10 and the administrator terminal 20, and controls paging by the base station 60 toward the communication terminals. Sharing the eDRX cycle and the PTW enables the base station 60 and the MME to send out a paging message at the timing at which the electronic timepiece 10 is in the PTW. The administrator terminal 20, which is a smartphone, always operates with DRX since its battery capacity is sufficiently large for electric power that is consumed by communication waiting.

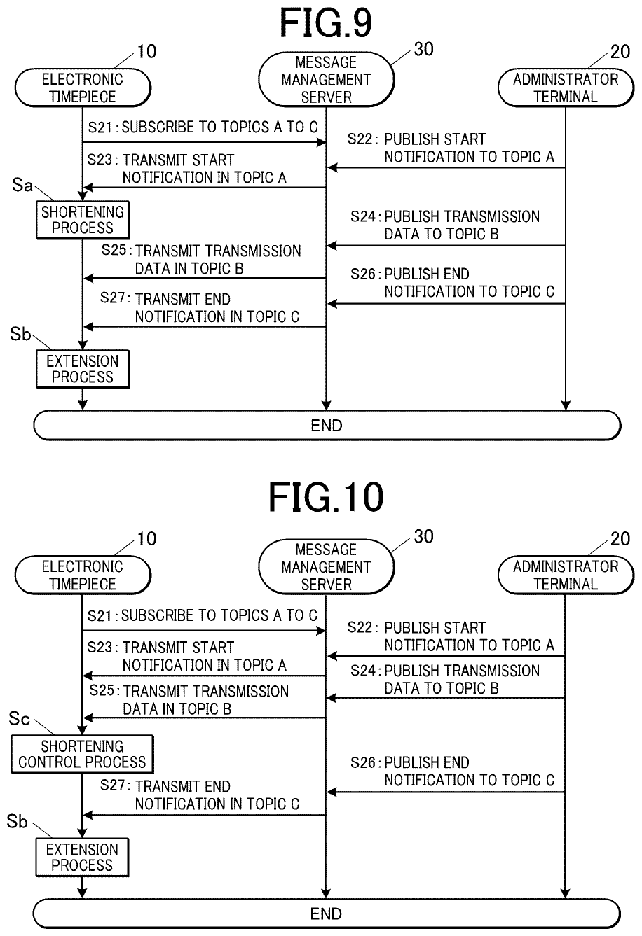

Next, the MQTT protocol will be described with reference to FIG. 6. The MQTT protocol is one of publish-subscribe asynchronous communication protocols. In the MQTT protocol, a device operating as a publisher and a device operating as a subscriber transmit and receive data to and from one another via a device operating as a broker. In this embodiment, the control processor 50 operates as the publisher, and the electronic timepiece 10 or the administrator terminal 20 operates as the subscriber. FIG. 6 illustrates a case where the electronic timepiece 10 operates as the subscriber. As described later with reference to FIG. 9, the electronic timepiece 10 or the administrator terminal 20 may function as the publisher. In the MQTT protocol, the broker manages topics to which transmission/reception data are allocated. In this embodiment, the message management server 30 operating as the broker stores data of topics including topics A to C in the topic data storage area 31. The subscriber registers itself in the broker (i.e., requests the broker to register the subscriber) to subscribe to topics of data that the subscriber wishes to receive. The publisher specifies a topic and transmits (publishes) data to the broker. When data is published to a topic to which the subscriber subscribes (i.e., when the topic is updated), the broker transmits (distributes) the data of (registered in) the topic to the subscriber. In the example illustrated in FIG. 6, the electronic timepiece 10 as the subscriber has registered itself to subscribe to the topics A to C, and in response to data being published to the topic A by the control processor 50 as the publisher (data being stored in the topic A of the topic data storage area 31), the data is transmitted from the message management server 30 to the electronic timepiece 10. Thus, in the MQTT protocol, the publisher and the subscriber can perform data communication via the broker, without being aware of each other's presence.

Data distribution of topics from the message management server 30 to the electronic timepiece 10 is performed at the timing of the PTW in DRX or eDRX, the timing been shared in advance by the electronic timepiece 10 and the base station 60. To be specific, when data is published to one of the topics A to C, the data is transmitted from the message management server 30 to the base station 60, and the base station 60 transmits a paging message to the electronic timepiece 10 at the timing of the PTW in DRX or eDRX, and upon establishing communication with the electronic timepiece 10 that has responded to the paging message, transmits the data of the topic to the electronic timepiece 10.

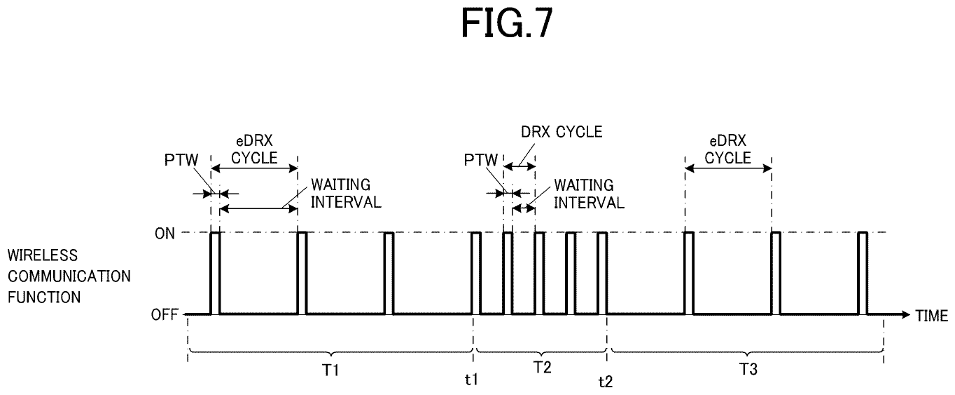

If the waiting cycle of the electronic timepiece 10 is set at the eDRX cycle to save power, depending on a timing or a standard value set as the waiting cycle, a long delay (e.g., tens of seconds to tens of minutes) occurs from when a topic is updated to when data thereof is received by the electronic timepiece 10. Therefore, the CPU 11 of the electronic timepiece 10 of this embodiment normally sets the waiting cycle at the eDRX cycle, and performs a shortening process to shorten the waiting interval in response to a predetermined start notification (certain notification or first notification) being received from the administrator terminal 20. For example, the CPU 11 shortens the waiting interval by shortening the waiting cycle from the eDRX cycle to the DRX cycle. In order to realize this operation of the electronic timepiece 10, in the communication system 1 of this embodiment, the control processor 50 publishes the start notification to the topic A when at least one time of data transmission (one time of data transmission or multiple consecutive times of data transmission) from the administrator terminal 20 to the electronic timepiece 10 is performed. The topic A may only be used to transmit/receive the start notification. For example, the electronic timepiece 10 receives the start notification transmitted from the control processor 50 at a time point t1 illustrated in FIG. 7. During a period T1 before the time point t1, the waiting cycle of the electronic timepiece 10 is set at the eDRX cycle. Upon receiving the start notification at the time point t1, the CPU 11 of the electronic timepiece 10 performs the shortening process to shorten the waiting cycle to the DRX cycle. Accordingly, if data is published to one of the topics A to C from the administrator terminal 20 in a period T2 after the time point t1, the electronic timepiece 10 can receive the data timely (with a short delay).

In addition, the CPU 11 of the electronic timepiece 10 performs an extension process to extend the waiting interval if a predetermined extension execution condition (certain condition) is satisfied after performing the shortening process. For example, the CPU 11 extends the waiting interval by extending the waiting cycle from the DRX cycle to the eDRX cycle. The CPU 11 determines that the extension execution condition is satisfied and performs the extension process, for example, if a predetermined end notification (second notification) indicating the end of data transmission by the administrator terminal 20 is received, which is hereinafter referred to as “first determination method”. In order that the CPU 11 can make the determination with the first determination method, when the aforementioned at least one time of data transmission from the administrator terminal 20 to the electronic timepiece 10 finishes, the control processor 50 publishes the end notification to the topic C. The topic C may only be used to transmit/receive the end notification. The CPU 11 may determine that the extension execution condition is satisfied and perform the extension process if a period during which no transmission data is received from the administrator terminal 20 continues for a first waiting time after the CPU 11 performs the shortening process, which is hereinafter referred to as “second determination method”. The first waiting time is predetermined and registered in the storage 13. The first waiting time may be changeable by a user operation. The CPU 11 may determine that the extension execution condition is satisfied and perform the extension process if a user operation as an instruction to end data reception is made on/with the operation receiver 15 of the electronic timepiece 10, which is hereinafter referred to as “third determination method”. Two or all of the first to third determination methods may be combined. For example, in the case of combination of the first determination method and the second determination method, the CPU 11 determines that the extension execution condition is satisfied and performs the extension process when one of the two conditions, reception of the end notification or elapse of the first waiting time, is satisfied. In the example illustrated in FIG. 7, the electronic timepiece 10 receives the end notification or the length of the period T2 reaches the first waiting time at a time point t2. At this time point t2, the CPU 11 performs the extension process. Accordingly, during a period T3 after the time point t2, the waiting cycle is set at the eDRX cycle, which is longer than the DRX cycle. Performing the extension process can reduce power consumption of the electronic timepiece 10 in the period during which no data is transmitted from the administrator terminal 20.

The method of shortening the waiting interval in the shortening process is not limited to the one described above. For example, the CPU 11 of the electronic timepiece 10 may shorten the waiting interval by changing the waiting cycle from a certain eDRX cycle (corresponding to the “first cycle”) to another eDRX cycle (corresponding to the “second cycle”) shorter than the certain eDRX cycle. As another example, the CPU 11 may shorten the waiting interval by extending the PTW. Shortening of the waiting cycle and extension of the PTW may be combined.

The method of extending the waiting interval in the extension process is not limited to the one described above. For example, if the waiting cycle after shortened by the shortening process is a certain eDRX cycle (corresponding to the “second cycle”), the CPU 11 of the electronic timepiece 1 may extend the waiting interval by changing the waiting cycle from the certain eDRX cycle to another eDRX cycle (corresponding to the “first cycle”) longer than the certain eDRX cycle. The waiting interval after extended by the extension process may be the same as or different from the waiting interval before shortened by the shortening process. As another example, the CPU 11 may extend the waiting interval by shortening the PTW. Extension of the waiting cycle and shortening of the PTW may be combined.

If data is published to the topic B in a period that is after transmission of the start notification by the control processor 50 but before transmission of the end notification thereby, this data is transmitted by the message management server 30 to the electronic timepiece 10 that is awaiting data reception on the DRX cycle.

Since the amount of data transmittable via the message management server 30 is limited, a large amount of data, such as voice data, may be transmitted in HTTP, in which a larger amount of data is transmittable compared to the MQTT protocol. In other words, a large amount of data, such as voice data, may be transmitted from the administrator terminal 20 to the electronic timepiece 10 via the data storage server 40. HTTP is a server-client synchronous communication protocol. In HTTP, data transmission/reception is performed by the data storage server 40 as the server and the electronic timepiece 10 or the administrator terminal 20 as the client performing one-to-one synchronous communication. Therefore, when data is transmitted from the administrator terminal 20 to the electronic timepiece 10 via the data storage server 40, first, the administrator terminal 20 and the data storage server 40 are communicatively connected, and the data is transmitted from the administrator terminal 20 to the data storage server 40 and stored in the transmission data storage area 41, and next, the electronic timepiece 10 and the data storage server 40 are communicatively connected, and the data is transmitted from the data storage server 40 to the electronic timepiece 10 in response to a request made by the electronic timepiece 10.

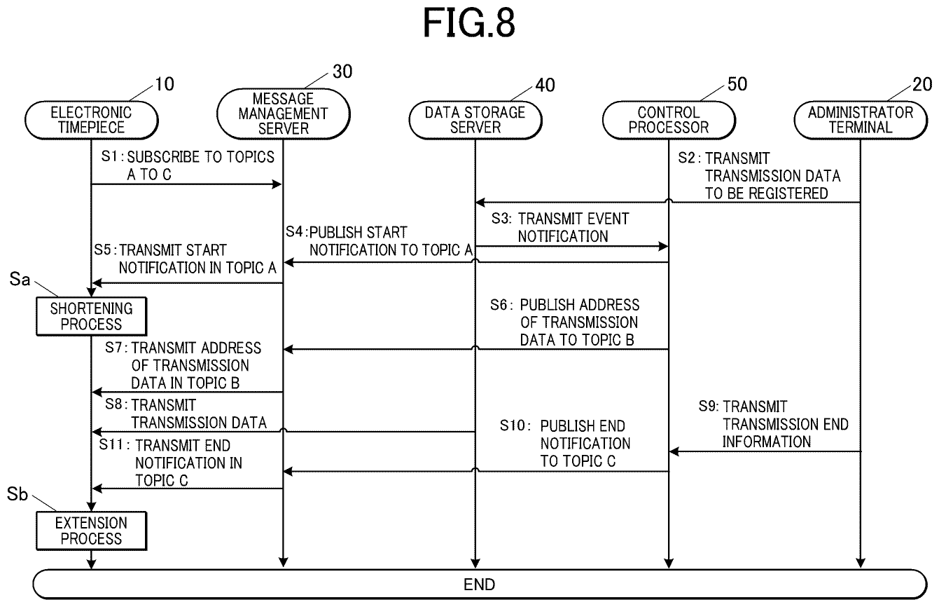

Hereinafter, a process flow for transmitting voice data from the administrator terminal 20 to the electronic timepiece 10 will be described with reference to FIG. 8. FIG. 8 illustrates data to be transmitted/received between the electronic timepiece 10, the administrator terminal 20, the message management server 30, the data storage server 40 and the control processor 50 and timings at which the data is transmitted/received. Although the main components that perform processes/steps in FIG. 8 are the CPU 11 of the electronic timepiece 10, the CPU 21 of the administrator terminal 20, a not-shown CPU of the message management server 30, a not-shown CPU of the data storage server 40 and a not-shown CPU of the control processor 50, for convenience, the electronic timepiece 10, the administrator terminal 20, the message management server 30, the data storage server 40 and the control processor 50 may be hereinafter described as the main components that perform the processes/steps. The same applies to FIG. 9 and FIG. 10.

In the transmission/reception flow illustrated in FIG. 8, first, the electronic timepiece 10 transmits, to the message management server 30, a request to subscribe to the topics A to C (Step S1). For example, the electronic timepiece 10 performs Step S1 at the timing at which the electronic timepiece 10 becomes connected to the network N after powered on. At the time of Step S1, the waiting cycle of the electronic timepiece 10 is set at the eDRX cycle. The message management server 30 that has received the request registers the electronic timepiece 10 as a distribution destination of the topics A to C. The fact that the electronic timepiece 10 subscribes to the topics A to C is shared in advance with the administrator terminal 20.

The administrator terminal 20 transmits, to the data storage server 40, transmission data (voice data in this embodiment) to be transmitted to the electronic timepiece 10 (Step S2). The data storage server 40 stores the received transmission data in the transmission data storage area 41. Upon storing/registering the voice data, the data storage server 40 transmits, to the control processor 50, an event notification including information indicating that the voice data is registered and information on the address of the voice data (Step S3). Upon receiving the event notification, the control processor 50 specifies the topic A and transmits the start notification to the message management server 30. In other words, in response to the first voice data from the administrator terminal 20 being registered in the data storage server 40, the control processor 50 publishes the start notification to the topic A (Step S4). The message management server 30 stores the start notification in the topic A of the topic data storage area 31. In response to the topic A being updated, the message management server 30 transmits the start notification registered in the topic A to the electronic timepiece 10 registered as the distribution destination of the topic A, and the electronic timepiece 10 receives the start notification (Step S5). In this step, as described above, the start notification transmitted from the message management server 30 to the base station 60 is transmitted from the base station 60 to the electronic timepiece 10 in the PTW of the eDRX cycle of the electronic timepiece 10. Upon receiving the start notification, the electronic timepiece 10 performs the above-described shortening process (Step Sa). For example, the electronic timepiece 10 shortens the waiting cycle from the eDRX cycle to the DRX cycle. Thereafter, the electronic timepiece 10 awaits data reception from the message management server 30 on the DRX cycle.

The control processor 50, after transmitting the start notification, specifies the topic B and transmits the address of the transmission data registered in the data storage server 40 in Step S2 to the message management server 30. In other words, the control processor 50 publishes the address of the transmission data to the topic B (Step S6). The message management server 30 stores the address received from the control processor 50 in the topic B of the topic data storage area 31. In response to the topic B being updated, the message management server 30 transmits the address registered in the topic B to the electronic timepiece 10 registered as the distribution destination of the topic B, and the electronic timepiece 10 receives the address (Step S7). In this step, the address transmitted from the message management server 30 to the base station 60 is transmitted from the base station 60 to the electronic timepiece 10 in the PTW of the DRX cycle of the electronic timepiece 10. The address of the transmission data may be included in the start notification of the topic A, which is transmitted in Step S4. In this case, the electronic timepiece 10 can obtain the address by receiving the start notification in Step S5, and therefore Steps S6 and S7 can be omitted.

Upon receiving the address, the electronic timepiece 10 specifies the received address and transmits a transmission request (request) for the transmission data (voice data) to the data storage server 40. The timing at which the transmission request is transmitted is not bounded by the DRX cycle, and therefore the transmission request can be transmitted at any timing. Upon receiving the transmission request, the data storage server 40 transmits the transmission data stored in the transmission data storage area 41 to the electronic timepiece 10, and the electronic timepiece 10 receives the transmission data (Step S8). If the administrator terminal 20 performs transmission of transmission data multiple times, after this Step S8, Steps S2, S3, S6, S7 and S8 are performed each time the administrator terminal 20 performs transmission of transmission data.

The administrator terminal 20, after transmitting the transmission data, transmits transmission end information indicating that transmission has finished, namely, indicating the end of transmission, to the control processor 50 (Step S9). Upon receiving the transmission end information, the control processor 50 specifies the topic C and transmits the end notification to the message management server 30. In other words, the control processor 50 publishes the end notification to the topic C (Step S10). The message management server 30 stores the end notification in the topic C of the topic data storage area 31. In response to the topic C being updated, the message management server 30 transmits the end notification registered in the topic C to the electronic timepiece 10 registered as the distribution destination of the topic C, and the electronic timepiece 10 receives the end notification (Step S11). Upon receiving the end notification, the electronic timepiece 10 determines that the extension execution condition is satisfied and performs the above-described extension process (Step Sb). For example, the electronic timepiece 10 extends the waiting cycle from the DRX cycle to the eDRX cycle. As described above, the electronic timepiece 10 may determine that the extension execution condition is satisfied and perform the extension process of Step Sb if the period during which no transmission data is received from the administrator terminal 20 continues for the first waiting time after the last Step S8, in which the electronic timepiece 10 receives transmission data. Thereafter, the electronic timepiece 10 awaits data reception from the message management server 30 on the eDRX cycle. Then, the process may be returned to Step S2 so that the processes in Step S2 and the subsequent steps are repeated.

Although not illustrated in FIG. 8, voice data can also be transmitted from the electronic timepiece 10 to the administrator terminal 20. In this case, first, the electronic timepiece 10 transmits voice data to the data storage server 40, and accordingly the control processor 50 publishes the address of the voice data to the topic B of the message management server 30. The administrator terminal 20 that has registered itself to subscribe to the topics A to C receives the voice data in response to the topic B being updated. Since the administrator terminal 20 always operates with DRX, the administrator terminal 20 does not perform either the shortening process or the extension process. However, if the administrator terminal 20 is configured to switch between eDRX and DRX to reduce power consumption, the administrator terminal 20 may perform the shortening process and the extension process as the electronic timepiece 10 does. In this case, in response to the first voice data from the electronic timepiece 10 being registered in the data storage server 40, the control processor 50 may publish the start notification to the topic A, and the administrator terminal 20 may perform the shortening process in response to the start notification. In addition, the administrator terminal 20 may perform the extension process in response to the control processor 50 publishing the end notification to the topic C.

Next, a process flow in a case where data is transmitted from the administrator terminal 20 to the electronic timepiece 10 not via the data storage server 40 but only via the message management server 30 will be described with reference to FIG. 9. The process flow illustrated in FIG. 9 is suitable for transmission/reception of a small amount of data, such as state data or text data described above. Step S21 in FIG. 9 is the same as Step S1 in FIG. 8. In FIG. 9, when the administrator terminal 20 starts data transmission to the electronic timepiece 10, the administrator terminal 20 specifies the topic A and transmits the start notification to the message management server 30. In other words, the administrator terminal 20 publishes the start notification to the topic A (Step S22). Steps S23 and Sa are the same as Steps S5 and Sa in FIG. 8, respectively. After transmitting the start notification in Step S22, the administrator terminal 20 publishes transmission data to the topic B (Step S24). The message management server 30 stores the transmission data in the topic B of the topic data storage area 31. In response to the topic B being updated, the message management server 30 transmits the transmission data registered in the topic B to the electronic timepiece 10, and the electronic timepiece 10 receives the transmission (Step data S25). When the administrator terminal 20 finishes data transmission to the electronic timepiece 10, the administrator terminal 20 specifies the topic C and transmits the end notification to the message management server 30. In other words, the administrator terminal 20 publishes the end notification to the topic C (Step S26). Steps S27 and Sb are the same as Steps S11 and Sb in FIG. 8, respectively. Thus, in the flow illustrated in FIG. 9, instead of the address of data, the data itself is transmitted through the topic B. Although not illustrated in FIG. 9, in the case of the flow illustrated in FIG. 9 too, data can also be transmitted from the electronic timepiece 10 to the administrator terminal 20.

In each of the process flows illustrated in FIG. 8 and FIG. 9, if the electronic timepiece 10 transmits transmission data to the administrator terminal 20 before receiving the start notification, the CPU 11 may perform the shortening process in response to a trigger different from the start notification. For example, the CPU 11 may perform the shortening process by being triggered, for example, by the operation receiver 15 receiving a user operation that instructs the electronic timepiece 10 to perform data transmission or by the motion sensor 16 detecting a predetermined movement of the electronic timepiece 10.

In the first Step S1 in FIG. 8 or Step S21 in FIG. 9, the electronic timepiece 10 subscribes to the topics A to C but not limited thereto. For example, in Step S1 or Step S21, the electronic timepiece 10 may subscribe to only the topic A for receiving the start notification, and after receiving the start notification, may subscribe to the topic B for receiving the address of transmission data or transmission data itself and the topic C for receiving the end notification. In each of FIG. 8 and FIG. 9, the topic A is used exclusively for transmitting/receiving the start notification, the topic B is used exclusively for transmitting/receiving the address of transmission data or transmission data itself, and the topic C is used exclusively for transmitting/receiving the end notification. Instead, a single topic may be used for transmitting/receiving the start notification, the address of transmission data, transmission data itself and the end notification. In this case, in a message to be transmitted, it is described that this is the start notification or the end notification.

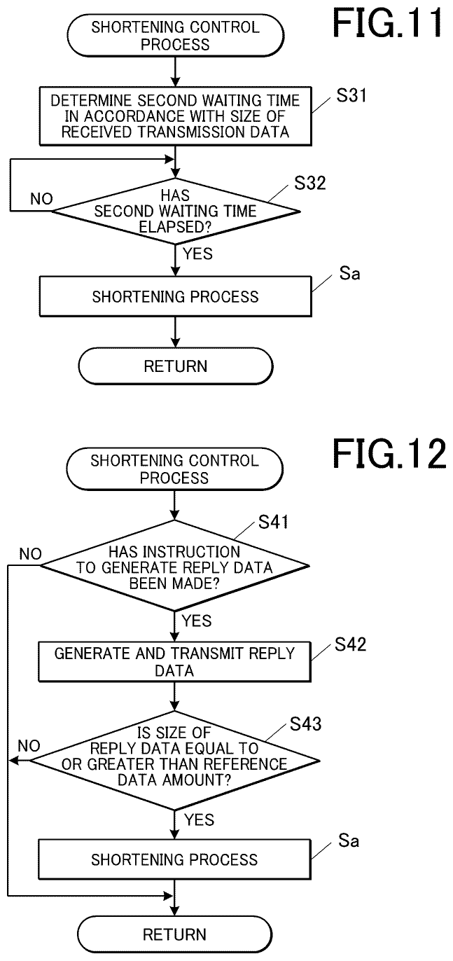

Next, a modification of the above embodiment will be described with reference to FIG. 10 to FIG. 12. Hereinafter, different points from the above embodiment will be described, and descriptions of points the same as or similar to the above embodiment will be omitted. This modification has been made by modifying the flow illustrated in FIG. 9. This modification is based on the assumption that after the start notification and the first data thereafter are transmitted from the administrator terminal 20 to the electronic timepiece 10, no additional data is transmitted from the administrator terminal 20 to the electronic timepiece 10 until data (reply) is transmitted from the electronic timepiece 10 to the administrator terminal 20. As illustrated in FIG. 10, the process flow of this modification differs from the one illustrated in FIG. 9 in that instead of the shortening process (Step Sa) in FIG. 9, the electronic timepiece 10 performs a shortening control process (Step Sc) after Step S25. This shortening control process includes the shortening process (Step Sa) as illustrated in FIG. 11. In this modification, the CPU 11 of the electronic timepiece 10 performs the shortening process (Step Sa) at the timing at which the second waiting time has elapsed from the reception of the start notification. In addition, the CPU 11 determines the second waiting time on the basis of the contents of the transmission data received first from the administrator terminal 20 after the start notification is received.

To be specific, as illustrated in FIG. 11, in the shortening control process, the CPU 11 determines the second waiting time in accordance with the size of the transmission data (e.g., the number of seconds of the voice data) received in Step S25 (Step S31). For example, the CPU 11 determines the second waiting time such that the longer the voice data, the longer the second waiting time. As a specific example, if the length of the voice data is 15 seconds, the CPU 11 adds a time for the person to be watched to play the voice data, namely, 15 seconds, to a time for the person to be watched to record his/her voice for a reply, for example, 10 seconds, thereby obtaining and determining 25 seconds as the second waiting time. Thus, the electronic timepiece 10 can reduce power consumption by maintaining the eDRX operation until the person to be watched replies, namely, in the period during which no data is transmitted from the administrator terminal 20. Thereafter, the CPU 11 repeatedly determines whether the second waiting time has elapsed since the start notification was received (Step S32). If the CPU 11 determines that the second waiting time has elapsed (Step S32; YES), the CPU 11 performs the shortening process (Step Sa). Upon completing the shortening process, the CPU 11 ends the shortening control process. Although not illustrated in FIG. 10, after the shortening control process (Step Sc) but before Step S26, data is transmitted from the administrator terminal 20 to the electronic timepiece 10 via the message management server 30.

The second waiting time may be determined on the basis of characteristics of voice data other than its length (e.g., the determination/recognition result of whether it is actually data of a (speaking) voice, its volume, etc.). Even if transmission data is not voice data but other data, the second waiting time can be determined with a predetermined method based on the contents of the transmission data. For example, if transmission data is text data, the second waiting time may be determined such that the larger the amount of the text data, the longer the second waiting time.

The CPU 11 may perform the shortening process at the timing at which the CPU 11 causes the communicator 19 to transmit data of a reply, which is hereinafter referred to as “reply data”, to the administrator terminal 20 after the start notification is received. The reply data may be voice data as a reply to voice data received, or not voice data but text data as a reply to voice data received, for example. Thus, the electronic timepiece 10 can reduce power consumption by maintaining the eDRX operation until the person to be watched replies, namely, in the period during which no additional data is transmitted from the administrator terminal 20. The CPU 11 may perform the shortening process at the timing at which the CPU 11 causes the communicator 19 to transmit reply data having a size equal to or greater than a reference data amount to the administrator terminal 20. In other words, the CPU 11 may not perform the shortening process if reply data transmitted to the administrator terminal 20 is data having a size less than the reference data amount. Thus, the electronic timepiece 10 can reduce power consumption by maintaining the eDRX operation, for example, in a case where voice data as a reply from the electronic timepiece 10 to the administrator terminal 20 is extremely short (e.g., a reply of only one word, such as “Roger” or “Okay”), assuming that there is no reply from the administrator terminal 20.

In the case where the CPU 11 of the electronic timepiece 10 performs the shortening process at the timing of transmission of reply data as described above, the CPU 11 performs the shortening control process illustrated in FIG. 12 in Step Sc of FIG. 10. In this shortening control process, the CPU 11 determines whether a user operation as an instruction to generate reply data has been made (Step S41). If the CPU 11 determines that the user operation has been made (Step S41; YES), the CPU 11 generates reply data in accordance with the user's instruction and publishes the reply data to the topic B to transmit the reply data to the administrator terminal 20 (Step S42). The CPU 11 determines whether the size of the transmitted reply data is equal to or greater than the reference data amount (Step S43). If the CPU 11 determines that the size of the reply data is equal to or greater than the reference data amount (Step S43; YES), the CPU 11 performs the shortening process (Step Sa) and ends the shortening control process. If the CPU 11 determines in Step S41 that the user operation as the instruction to generate reply data has not been made (Step S41; NO), or if the CPU 11 determines in Step S43 that the size of the reply data is less than the reference data amount (Step S43; NO), the CPU 11 ends the shortening control process without performing the shortening process. Regardless of the size of reply data, the CPU 11 may always perform the shortening process at the timing of the first transmission of reply data. In this case, Step S43 is omitted.

Although FIG. 10 illustrates the process flow modified from the process flow illustrated in FIG. 9, a process flow modified from the process flow illustrated in FIG. 8 may be created. In this case, Step Sa in FIG. 8 is removed, and the electronic timepiece 10 performs the shortening control process after Step S8.

As described above, there has been known a technology for an electronic device provided with a wireless communication function to reduce power consumption by discontinuously waiting for the start of communication with an external communication device at predetermined waiting intervals, namely, with a predetermined waiting interval. However, as the waiting interval is made longer in order to reduce power consumption, reception of data from the external communication device is more likely to be delayed. On the other hand, as the waiting interval is made shorter in order to reduce delay in reception of data, a communication try is made at a higher frequency and accordingly power consumption increases. Thus, the conventional technology is unlikely to achieve both reduction of power consumption and timely reception of data.

In order to deal with these, the electronic timepiece 10 of the above embodiment includes the CPU 11 (processor) and the communicator 19 that communicates with the administrator terminal 20 via the message management server 30 and the data storage server 40. The communicator 19 discontinuously awaits data reception from the message management server 30 at predetermined waiting intervals, namely, with a predetermined waiting interval. The CPU 11 performs the shortening process to shorten the waiting interval in response to the communicator 19 receiving the start notification via the message management server 30, and after performing the shortening process, performs the extension process to extend the waiting interval in response to the extension execution condition being satisfied. Thus, the electronic timepiece 10 can reduce power consumption by normally awaiting data reception on the eDRX cycle and also, by shortening the waiting cycle to the DRX cycle in response to the start of data transmission by the administrator terminal 20, can reduce delay in reception of data thereafter. In other words, the electronic timepiece 10 can achieve both reduction of power consumption and timely reception of data.

Further, the CPU 11 performs the shortening process in response to the communicator 19 receiving the start notification indicating the start of data transmission by the administrator terminal 20, and determines that the extension execution condition is satisfied and performs the extension process in response to the communicator 19 receiving the end notification indicating the end of the data transmission. Thus, the electronic timepiece 10 can perform the shortening process at an appropriate timing at which the administrator terminal 20 starts data transmission and also can perform the extension process at an appropriate timing at which the administrator terminal 20 finishes data transmission.

Further, the CPU 11 determines that the extension execution condition is satisfied and performs the extension process in response to the period during which the communicator 19 receives no transmission data from the administrator terminal 20 continuing for the first waiting time after the CPU 11 performs the shortening process. Thus, the electronic timepiece 10 can save electric power that is required to receive the end notification.

Further, the communicator 19 communicates with the administrator terminal 20 via the message management server 30 and communicates with the administrator terminal 20 via the data storage server 40. The CPU 11 performs the shortening process in response to the communicator 19 receiving the start notification from the administrator terminal 20 via the message management server 30, and after performing the shortening process, causes the communicator 19 to receive transmission data from the administrator terminal 20 via the data storage server 40. Thus, the electronic timepiece 10 can receive the start notification by low-power-consumption communication in accordance with the MQTT protocol and also can receive data of a larger amount using HTTP.

Further, in the shortening process, the CPU 11 shortens the waiting interval by shortening the waiting cycle on which the communicator 19 discontinuously awaits data reception from the message management server 30 from the eDRX cycle to the DRX cycle, and in the extension process, the CPU 11 extends the waiting interval by extending the waiting cycle from the DRX cycle to the eDRX cycle. Thus, the electronic timepiece 10 can adjust the waiting interval with the simple process of switching between the DRX cycle and the eDRX cycle.

Further, in the shortening process, the CPU 11 may shorten the waiting interval by shortening the waiting cycle on which the communicator 19 discontinuously awaits data reception from the message management server 30 from an eDRX cycle at the time to another eDRX cycle shorter than the aforementioned eDRX cycle, and in the extension process, the CPU 11 may extend the waiting interval by extending the waiting cycle from an eDRX cycle at the time to another eDRX cycle longer than the aforementioned eDRX cycle. Thus, the electronic timepiece 10 can adjust the waiting interval with the simple process of switching between eDRX cycles different from one another in length.

Further, in the modification, the CPU 11 performs the shortening process at the timing at which the second waiting time has elapsed from the reception of the start notification by the communicator 19, and determines the second waiting time on the basis of the contents of transmission data from the administrator terminal 20 that the communicator 19 receives first after receiving the start notification or on the basis of the contents of the start notification. Thus, the electronic timepiece 10 can reduce power consumption by maintaining the eDRX operation until the person to be watched replies, namely, in the period during which no additional data is transmitted from the administrator terminal 20.

Further, in the modification, the CPU 11 performs the shortening process at the timing at which the CPU 11 causes the communicator 19 to transmit reply data to the administrator terminal 20 after the communicator 19 receives the start notification. Thus, the electronic timepiece 10 can reduce power consumption by maintaining the eDRX operation until the person to be watched replies, namely, in the period during which no additional data is transmitted from the administrator terminal 20.

Further, in the modification, the CPU 11 performs the shortening process at the timing at which the CPU 11 causes the communicator 19 to transmit reply data having a size equal to or greater than the reference data amount to the administrator terminal 20. Thus, the electronic timepiece 10 can reduce power consumption by maintaining the eDRX operation, for example, in the case where voice data as a reply from the electronic timepiece 10 to the administrator terminal 20 is extremely short, assuming that there is no reply from the administrator terminal 20.

Further, in the communication control method of the above embodiment, the CPU 11 (computer) performs the shortening process to shorten the waiting interval in response to the communicator 19 receiving the start notification via the message management server 30, and after performing the shortening process, performs the extension process to extend the waiting interval in response to the extension execution condition being satisfied. Thus, the communication control method can achieve both reduction of power consumption and reduction of delay in reception of data.

Further, the storage 13 as the storage medium of the above embodiment stores the programs 131. One or more of the programs 131 cause the CPU 11 (computer) to perform the shortening process to shorten the waiting interval in response to the communicator 19 receiving the start notification via the message management server 30, and after performing the shortening process, perform the extension process to extend the waiting interval in response to the extension execution condition being satisfied. Thus, the program(s) 131 stored in/by the storage 13 can achieve both reduction of power consumption and reduction of delay in reception of data.

The present disclosure is not limited to the above embodiment but can be modified in various aspects. For example, in the above embodiment, the certain notification is the start notification but not limited thereto. The certain notification may be the first transmission data from the administrator terminal 20 to the electronic timepiece 10 in FIG. 9 or FIG. 10. In this case, the administrator terminal 20 publishing the transmission data to the topic A may indicate that the transmission data is data corresponding to the start notification. Alternatively, a message that this is the start notification may be added to the transmission data. Further, the certain notification may be transmission data received first from the administrator terminal 20 by the electronic timepiece 10 using a certain/appropriate method, the electronic timepiece 10 operating with eDRX, being regarded as the start notification.

Further, the communication protocol between the electronic timepiece 10 and the administrator terminal 20 is not limited to the MQTT protocol and HTTP but may be any appropriate communication protocol.

Further, the wireless communication method between the electronic timepiece 10 and the base station 60 is not limited to LPWA but may be any wireless communication method capable of changing the waiting interval.

Further, although in the above embodiment, the electronic timepiece 10 is the electronic device, the electronic device may be any device that operates by electric power of a battery. For example, the electronic device may be a portable device, such as a smartphone or a tablet terminal, or a wearable device, such as an activity meter or a blood pressure monitor. Further, although in the above embodiment, the administrator terminal 20 as the communication device is a smartphone, the communication device may be any device capable of communicating with the electronic device.

Further, although in the above embodiment, the communication system 1 is applied to the watching service to watch the person to be watched, the application of the communication system 1 is not limited thereto. For example, the communication system 1 may be used to manage a worker(s) who works at a worksite, such as a construction site. In this case, the worker has the electronic device (e.g., electronic timepiece 10), and an administrator who manages the worker operates the communication device (e.g., administrator terminal 20). Further, the electronic device may be worn by or attached to not a person but another target to be watched/monitored, such as an animal or luggage.

Further, although in the above embodiment, the message management server 30 and the data storage server 40 of the cloud platform 100 are each used as the server, the server is not limited thereto but may be any information processing device that relays communication between the electronic device and the communication device.

Further, although in the above, the flash memory of the storage 13 is used as the computer-readable medium of the program(s) of the present disclosure, the computer-readable medium is not limited thereto. As the computer-readable medium, an information storage/recording medium, such as an HDD, an SSD or a CD-ROM, is usable. Further, as a medium that provides data of the program(s) of the present disclosure via a communication line, a carrier wave is also applicable to the present disclosure.

It is a matter of course that the detailed configuration and the detailed operation of each component of the communication system 1 of the above embodiment can be changed as appropriate without departing from the scope of the present disclosure.

Although one or more embodiments or the like of the present disclosure have been described above, the scope of the present disclosure is not limited to the embodiments or the like described above but includes the scope of claims below and their equivalents.

1. An electronic device comprising:
a processor; and
a communicator that communicates with an external communication device via a server,
wherein the communicator discontinuously awaits data reception from the server with a predetermined waiting interval, and
wherein the processor
performs a shortening process to shorten the waiting interval in response to the communicator receiving a certain notification via the server, and
after performing the shortening process, performs an extension process to extend the waiting interval in response to a certain condition being satisfied.

2. The electronic device according to claim 1, wherein the processor
performs the shortening process in response to the communicator receiving, as the certain notification, a first notification indicating a start of data transmission by the external communication device, and
determines that the certain condition is satisfied and performs the extension process in response to the communicator receiving a second notification indicating an end of the data transmission.

3. The electronic device according to claim 1, wherein the processor determines that the certain condition is satisfied and performs the extension process in response to a period during which the communicator receives no transmission data from the external communication device continuing for a first waiting time after the processor performs the shortening process.

4. The electronic device according to claim 1,
wherein the server includes a first server and a second server different from the first server,
wherein the communicator communicates with the external communication device via the first server and communicates with the external communication device via the second server, and
wherein the processor
performs the shortening process in response to the communicator receiving the certain notification from the external communication device via the first server, and
after performing the shortening process, causes the communicator to receive transmission data from the external communication device via the second server.

5. The electronic device according to claim 1,
where the processor
in the shortening process, shortens the waiting interval by shortening a waiting cycle on which the communicator discontinuously awaits the data reception from the server from a first cycle to a second cycle shorter than the first cycle, and
in the extension process, extends the waiting interval by extending the waiting cycle from the second cycle to the first cycle,
wherein the first cycle is a standard value among standard values defined for the waiting cycle in extended discontinuous reception (eDRX), and
wherein the second cycle is a standard value defined for the waiting cycle in discontinuous reception (DRX).

6. The electronic device according to claim 1,
wherein the processor
in the shortening process, shortens the waiting interval by shortening a waiting cycle on which the communicator discontinuously awaits the data reception from the server from a first cycle to a second cycle shorter than the first cycle, and
in the extension process, extends the waiting interval by extending the waiting cycle from the second cycle to the first cycle,
wherein the first cycle is a standard value among standard values defined for the waiting cycle in extended discontinuous reception (eDRX), and
wherein the second cycle is, among the standard values defined for the waiting cycle in the eDRX, a standard value shorter than the standard value of the first cycle.

7. The electronic device according to claim 1, wherein the processor
performs the shortening process at a timing at which a second waiting time has elapsed from the reception of the certain notification by the communicator, and
determines the second waiting time based on a content of transmission data from the external communication device that the communicator receives first after receiving the certain notification or based on a content of the certain notification.

8. The electronic device according to claim 1, wherein the processor performs the shortening process at a timing at which the processor causes the communicator to transmit data to the external communication device after the communicator receives the certain notification.

9. The electronic device according to claim 8, wherein the processor performs the shortening process at the timing at which the processor causes the communicator to transmit the data having a size equal to or greater than a reference data amount to the external communication device.

10. A communication control method that is performed by a computer of an electronic device including a communicator that communicates with an external communication device via a server and discontinuously awaits data reception from the server with a predetermined waiting interval, the communication control method comprising:
performing a shortening process to shorten the waiting interval in response to the communicator receiving a certain notification via the server; and
after performing the shortening process, performing an extension process to extend the waiting interval in response to a certain condition being satisfied.

11. The communication control method according to claim 10,
wherein the performing of the shortening process includes performing the shortening process in response to the communicator receiving, as the certain notification, a first notification indicating a start of data transmission by the external communication device, and
wherein the performing of the extension process includes determining that the certain condition is satisfied and performing the extension process in response to the communicator receiving a second notification indicating an end of the data transmission.

12. The communication control method according to claim 10, wherein the performing of the extension process includes determining that the certain condition is satisfied and performing the extension process in response to a period during which the communicator receives no transmission data from the external communication device continuing for a first waiting time after the computer performs the shortening process.

13. The communication control method according to claim 10,
wherein the server includes a first server and a second server different from the first server,
wherein the communicator communicates with the external communication device via the first server and communicates with the external communication device via the second server,
wherein the performing of the shortening process includes performing the shortening process in response to the communicator receiving the certain notification from the external communication device via the first server, and
wherein the communication control method further comprises after performing the shortening process, causing the communicator to receive transmission data from the external communication device via the second server.

14. The communication control method according to claim 10,
wherein the performing of the shortening process includes in the shortening process, shortening the waiting interval by shortening a waiting cycle on which the communicator discontinuously awaits the data reception from the server from a first cycle to a second cycle shorter than the first cycle,
wherein the performing of the extension process includes in the extension process, extending the waiting interval by extending the waiting cycle from the second cycle to the first cycle,
wherein the first cycle is a standard value among standard values defined for the waiting cycle in extended discontinuous reception (eDRX), and
wherein the second cycle is a standard value defined for the waiting cycle in discontinuous reception (DRX).

15. The communication control method according to claim 10,
wherein the performing of the shortening process includes in the shortening process, shortening the waiting interval by shortening a waiting cycle on which the communicator discontinuously awaits the data reception from the server from a first cycle to a second cycle shorter than the first cycle,
wherein the performing of the extension process includes in the extension process, extending the waiting interval by extending the waiting cycle from the second cycle to the first cycle,
wherein the first cycle is a standard value among standard values defined for the waiting cycle in extended discontinuous reception (eDRX), and
wherein the second cycle is, among the standard values defined for the waiting cycle in the eDRX, a standard value shorter than the standard value of the first cycle.

16. A non-transitory computer-readable storage medium storing a program causing, of an electronic device including a communicator that communicates with an external communication device via a server and discontinuously awaits data reception from the server with a predetermined waiting interval, a computer to:
perform a shortening process to shorten the waiting interval in response to the communicator receiving a certain notification via the server; and
after performing the shortening process, perform an extension process to extend the waiting interval in response to a certain condition being satisfied.

17. The non-transitory computer-readable storage medium according to claim 16, wherein the program causes the computer to:
perform the shortening process in response to the communicator receiving, as the certain notification, a first notification indicating a start of data transmission by the external communication device; and
determine that the certain condition is satisfied and perform the extension process in response to the communicator receiving a second notification indicating an end of the data transmission.

18. The non-transitory computer-readable storage medium according to claim 16, wherein the program causes the computer to determine that the certain condition is satisfied and perform the extension process in response to a period during which the communicator receives no transmission data from the external communication device continuing for a first waiting time after the computer performs the shortening process.

19. The non-transitory computer-readable storage medium according to claim 16,
wherein the server includes a first server and a second server different from the first server,
wherein the communicator communicates with the external communication device via the first server and communicates with the external communication device via the second server, and
wherein the program causes the computer to:
perform the shortening process in response to the communicator receiving the certain notification from the external communication device via the first server, and
after performing the shortening process, cause the communicator to receive transmission data from the external communication device via the second server.

20. The non-transitory computer-readable storage medium according to claim 16,
wherein the program causes the computer to:
in the shortening process, shorten the waiting interval by shortening a waiting cycle on which the communicator discontinuously awaits the data reception from the server from a first cycle to a second cycle shorter than the first cycle; and
in the extension process, extend the waiting interval by extending the waiting cycle from the second cycle to the first cycle,
wherein the first cycle is a standard value among standard values defined for the waiting cycle in extended discontinuous reception (eDRX), and
wherein the second cycle is a standard value defined for the waiting cycle in discontinuous reception (DRX).
